(19) United States
(12) Patent Application Publication
(10) Pub. No.: US 2002/0013848 A1
(43) Pub. Date: Jan. 31, 2002

(54) Secure network communications

(75) Inventor: Mathias Jean Rene Salle, Bristol (GB)

Correspondence Address: IP Administration, C/o Hewlett-Packard Company, 3404 East Harmony Road, Mail Stop 35, Ft. Collins, CO, 80528-9599, US

(73) Assignee: Hewlett-Packard Company

(21) Appl. No.: 09/878,006

(22) Filed: Jun. 8, 2001

(30) Foreign Application Priority Data
Jun. 9, 2000 (GB) 0014115.0

(51) Int. Cl. G06F 15/177; G06F 15/173

(52) U.S. Cl. 709/226; 709/220

(57) ABSTRACT

A method for a service provider (60) on a private network to provide a service for an external client (10) on an external network via a gateway (13) bridging the private and external networks, including the service provider carrying out the steps of allocating a virtual name to the service provider, making the virtual name available to a client (10) on the external network, binding the virtual name to the routing address of the gateway (60) on the external network and binding the virtual name to the routing address of the service provider (60) on the private network. The method finds particular application to network arrangements in which there is end-to-end security between the client (10) and the service provider (60) by providing a virtual name used globally for all routing so obviating the need for remapping of message address by the gateway (13).

### FIELD OF THE INVENTION

The present invention relates, generally, to secure network communications and, in particular, to methods of communication between a client connected to an external network and a service provider on a private network via a gateway bridging the private and external networks. The client may be connected to its own private network but such a private network, and a public network, e.g. the internet, by which the client communicates with the service provider, are all considered an external network relative to the service providers private network.

### BACKGROUND OF THE INVENTION

An example of such connected networks is one in which the private network of the service provider is connected to the internet by a gateway acting as a “firewall” to protect the private network from unwanted intrusion from users on the internet. The gateway is designed to allow only authorised messages to pass from one network to the other via itself. A client on the external network wishing to communicate with the service provider on the private network will first be connected to the gateway which will usually establish the credentials of the client and whether the client is authorised to communicate with the service provider. If authorised, communications are then established between the client and service provider via the gateway which functions as a relay for the client-service provider communications.

The routing of messages received by the gateway to the service provider can be carried out in a number of ways and perhaps with one or more security measures applied by the gateway. A known approach to routing messages to the service provider is to hide the identification of the service provider on the private network from the client and for the gateway to re-map messages received from client to the service provider, prior to forwarding them onwards, by modifying the to address in the message destined for the service provider to be the private network address of the service provider.

If the service provider wishes to advertise to the client another service or service provider, the gateway can be arranged to read the reference in the message being passed to the client, substitute a virtual name for the real name, store the cross-reference to the real name of the other service provider, and relay the modified message to the client. The virtual name is also bound to the gateway so messages addressed to the virtual name will be routed to the gateway. The gateway then re-maps received messages to this other service or service provider using the stored cross-reference. In this way the real name of the service providers on the private network are kept from the client on the external network so enhancing the security of the private network.

It will be appreciated that these so called application gateways require the gateway to understand the protocol being employed by the client and the service provider so the messages can be read, the re-mapping cross-references stored, and the message appropriately modified by the gateway to provide the relaying of messages from one to the other.

Another approach is the circuit level gateway in which a client establishes an authorised connection to the gateway using a first protocol which first protocol is then used to encapsulate messages in a second protocol destined for the service provider. The gateway receives the encapsulated messages and forwards them to the service provider having extracted them from the first protocol messages as received from the client. This is commonly referred to as a tunnelling. Again, if the gateway can understand the messages in the second protocol passing between the client and the service provider, the re-mapping carried out by the gateway can be automatically updated as new services or service providers are advertised to clients so, again, providing relaying while keeping the real names of the service providers from the client

Such updating of re-mapping information is not possible, however, if the messages tunnelled between the client and service provider cannot be understood by the gateway, for example, if the tunnelled messages are encrypted for end-to-end security between the client and service provider as provided, for example, by the system in the applicant's co-pending patent application U.S. Ser. No. 09/733014 the contents of which are incorporated herein by reference in its entirety.

The present invention has as its primary object the provision of methods in which the real names of service providers can be kept hidden from clients and which is of particular, but not exclusive, application to network arrangements in which there is end-to-end security between a client and a service provider.

### SUMMARY OF THE INVENTION

According to a first aspect of the present invention there is provided a method for a service provider on a private network to provide a service to an external client on an external network via a gateway bridging the private and external networks, including the service provider carrying out the steps of:

allocating a virtual name to the service provider;

making the virtual name available to the client on the external network;

binding the virtual name to the routing address of the gateway on the external network; and

binding the virtual name to the routing address of the service provider on the private network.

The client will direct communications to the virtual name of the service which by virtue of the binding to the routing address of the gateway will be routed to the gateway. The binding can be effected for internet communications, for example, by registering the virtual name as an alias of the gateway on publicly accessible DNS servers. The gateway then forwards the communications onwards using the binding of the virtual name on the private network which now provides the routing address of the service provider. The same virtual name is used globally for all routing with no requirement for re-mapping of addresses.

The virtual name may be bound to the routing address of the gateway and the routing address of the service provider by way of all external domain name server and private domain name server, respectively. A further approach is one in which the virtual name is bound to the routing address of the service provider on an internal naming service.

The method of the present invention has particular applicability to methods in which the client and the service provider communicate by way of an encrypted tunnelled session via the gateway.

The present invention may be used in various service provision scenarios. For example, the client may be on a second internal network distinct from the internal network of the service provider and with a second gateway bridging the second internal network and external network. In such a case the method of the present invention may include the steps of: allocating a second virtual name to the client; making the second virtual name available to the service provider; binding the second virtual name to the routing address of the second gateway on the external network; and binding the second virtual name to the routing address of the client on the second internal network.

As a further example there may be a second service provider on a second private network able to communicate with an external network via a second gateway bridging the second private network and the external network. In this case the method may include the steps of: allocating a second virtual name to the second service provider; making the second virtual name available to a client; binding the second virtual name to the routing address of the second gateway on the external network; and binding the second virtual name to the routing address of the second service provider on the second private network.

The private network of the service provider may be nested within one or more further private networks through which the client may wish to communicate via a series of one or more gateways. In this case the method may include binding the virtual name to routing address of the further gateway on the network external to the further private network.

According to another aspect of the present invention, there is provided a method of providing access to a server on a private network from an external client on an external network via a gateway bridging the private and external networks, the gateway supporting tunnelling of second messages to said server by encapsulating them in first messages routed to the gateway; the method involving:

(a) - allocating a virtual name to the server and mapping it by a first mapping to the routing address of the gateway on the external network and by a second mapping to the routing address of the server on the private network;

(b) - at said external client, using the virtual name to address a said first message and a said second message, the former encapsulating the latter;

(c) - using the first mapping to route the first message, with its encapsulated second message, to the gateway; and

(d) - using the second mapping to route the second message extracted at the gateway from the first message, to the server.

### BRIEF DESCRIPTION OF THE DRAWINGS

Embodiments of the invention will now be described by way of example only, with reference to the accompanying drawings of which:

FIG. 1 is a diagram of an end-to-end communication arrangement to which the present invention may be applied showing details of an embodiment of a Session Layer Security (SLS) protocol entity used to establish a secure session over the communication arrangement;

FIG. 2 is a diagram depicting tunnelling supported by nested sessions established by an SLS protocol entity;

FIG. 3 is a diagram illustrating the use of SLS entities in a resource mediation environment;

FIG. 4 is a diagram illustrating the use of an SLS plug-in web bowser for establishing a secure session with a resource mediation environment on a broker server;

FIG. 5 is a diagram illustrating exposure of a service of a private network to an external network, according to the present invention;

FIG. 6 is a diagram illustrating a network arrangement access of providing a service of a private network from an external network, according to the first invention;

FIG. 7 is a diagram showing the flow of messages in establishing an end-to-end secure communications link; and

FIGS. 8 to 12 are diagrams of filler network arrangements according to the present invention.

### BEST MODE OF CARRYING OUT THE INVENTION

Embodiments of the present invention will now be described as applied to a communications network in which a client, gateway and service provider communicate using a session-layer security protocol, and who for convenience will also be referred to as Alice, Bob and Charlie using the usual general entity naming convention. It should be noted, however, that the present invention is generally applicable to network arrangements in which a private and public (external) network are bridged by a gateway.

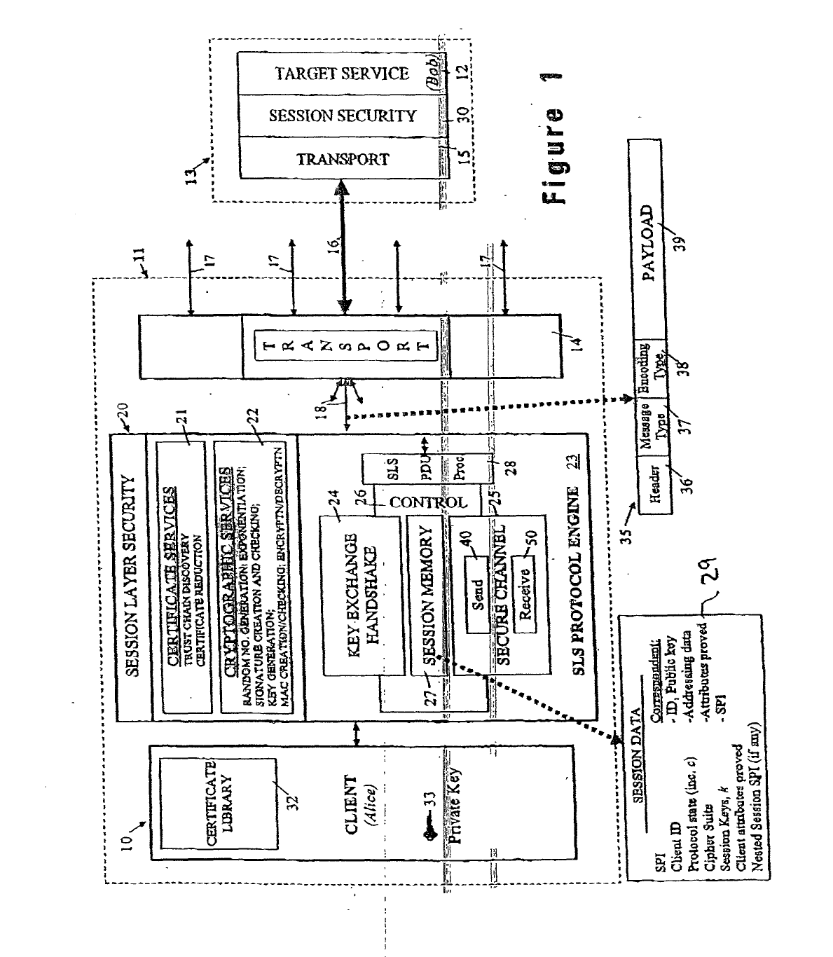

FIG. 1 depicts an end-to-end secure communication path between a client 10 of a first end system 11 and a target service 12 of a second end-system 13 which client 10 wishes to use. This communication path involves a reliable connection 16 established between the end systems 11, 13 by transport entities of 14, 15 of the two systems. The precise details of the transport mechanism used to establish and maintain connection 16 is not of importance to the present invention; however, by way of example, the connection 16 can be an internet TCP/IP connection. Typically, the transport entities 14, 15 are arranged to handle multiple simultaneous connections potentially of different types, and this is represented by arrows 17 in FIG. 1. Each connection, such as connection 16, may carry traffic for multiple simultaneous sessions of one or more applications (the client 10 being one such application) as is indicated by arrows 18. The following description will at first focus on the provision of security for a single secure session between the client 10 and service 12 over the connection 16, then how a tunnelled end-to-end secure session via a gateway is established and then how the present invention can be applied to such tunnelled sessions as an exemplary embodiment, only of the present invention.

Security for communication between client 10 and service 12 is provided at the level of a session by cooperating session-level security (‘SLS’) entities 20, 30 in end systems 11, 13 respectively, the SLS entity being logically located between the client 10 and transport entity 14 and the SLS entity 30 being logically located between service 12 and transport entity 15. Each SLS entity is capable of handling multiple simultaneous sessions involving different client-service pairings. The protocol operated between the SLS entities is herein referred to as the SLS protocol.

When the client 10 wishes to establish a communication session with service, the SLS entities first carry out a handshake procedure the purpose of which is two-fold:

to determine if each party has certain ‘attributes’ required of it by the other—if this is not the case, then a communication session is not established; and

to exchange cryptographic data to enable shared keys to be established for the communication session being established (if allowed).

Assuming the handshake was successful, the SLS entities are then responsible for operating the resultant secure channel established between the client 10 and service 12.

An ‘attribute’ expresses some property such as a name, a location, a credit limit, an owner or a role. Attributes are proved by certificates that are exchanged and authenticated to ensure that neither party (client or service) is making false claims about the possession of an attribute. Whilst the identity of the client or service constitutes an attribute, there is no a priori requirement that this attribute must be presented and verified—it is up to the parties (client 10, service 12) to specify what attributes they require of the other.

In the present arrangement, attributes are established by SPKI certificates which are explained in detail in C Ellison et al., “SPKI Certificate Theory”, IETF RFC2693 September 1999 and C Ellison et al, “SPKI Examples”, IETF RFC 2692 September 1999, for example. It should be noted that as uses herein, the term ‘attribute certificate’ means any signed electronic instrument bestowing an attribute on the subject of the certificate and therefore encompasses both SPKI ‘attribute’ certificates and SPKI ‘authorization’ certificates.

Proving that a party has a particular attribute means establishing a trust chain of valid certificates back to a party inherently trusted in relation to matters concerning the attribute. This trust chain may involve not only attribute certificates but also ‘name’ certificates. In this respect, it is useful to note that the issuer and subject of an SPKI certificate is fundamentally a principal constituted by a public key (or its hash). Of course, there will be a keyholder associated with the public key (this being the party holding the private key matching the public key) but that party may not be identified at all. The subject of certificate may also be specified by a name but in this case there should also name a certificate mapping the name to the corresponding principal.

A more detailed discussion of SPKI certificates and their use in providing attributes can be found in our co-pending U.S. Ser. No. 09/732954 entitled “Method and Apparatus for Discovering a Trust Chain Imparting a Required Attribute to a Subject” to which reference is directed.

In order to provide the means for implementing the foregoing features, the SLS entity 20 (and correspondingly the entity 30) comprises:

a certificate services block 21 for providing trust chain discovery and certificate reduction services;

a cryptographic services block 22 for providing signature creation and checking services and exponentiation services during the key-exchange handshake, key generation services for generating the session keys for the secure channel established following a successful handshake, and MAC (Message Authentication Code) creation checking services and encryption/decryption services for messages exchanged over the secure channel; and

a protocol engine 23 with a key exchange handshake functional block 24, a secure channel functional block 25, an SLS PDU processing block 28, and a control block 26.

The control block 26 is responsible for coordinating the other elements of the protocol engine 23 according to input received from the client 10 and present in the unencrypted header fields of messages received over connection 16 via the transport entity 14. As already mentioned, the SLS entity is capable of handling multiple simultaneous sessions and the control block 26 is responsible for correctly associating client input and messages with the appropriate secure communication session (or to initiate a new session if no session currently exists when client 10 requests to communicate with services 12); this it does by assigning an identifier to each secure session, this identifier being herein called the Security Parameters Identifier (SPI). The SPI is carried in clear by messages passed over the secure channel. The control block 26 stores information relevant to each session, including the related SPI, in a session memory 27 and whenever the protocol engine receives a message from transport entity 14, it uses the SPI to look up the appropriate session data. The session data can also be accessed by client ID. Block 29 in FIG. 1 indicates the most important data items held for each session.

The client holds its own private key 33 used for digitally signing messages during the key exchange to authenticate them as originating from itself. The signing functionality is provided by the cryptographic services block 22. The client also holds it own collection of SPKI certificates in certificate library 32 from which it can extract the certificates appropriate for proving that it has particular attributes. Whilst the client endeavours to keep a record of the chain of certificates appropriate for proving each of its attributes, it can call on the trust chain discovery functionality provided by the certificate services block 21 to help it find such a chain (a suitable form of trust-chain discovery engine is described in our above-mentioned co-pending patent application). The client 10 can also call on the certificate services block to prove that a set of certificates provided by the service 12 actually prove that the latter has required attributes (proving this may require not only the certificate reduction functionality of block 21, but also the trust chain discovery functionality if the certificates are presented out of order); the signature verification service of the cryptographic services block 22 will also be needed to verify that the certificates presented check out.

SLS is a layered protocol with a base layer implemented by the SLS PDU processor 28, the latter serving to assemble/disassemble SLS PDUs protocol layer (for example the key-exchange protocol operated by the handshake protocol engine 24 or the secure channel protocol operated by the secure channel protocol engine 25). The general form of the SLS PDUs is depicted in FIG. 1 for a PDU 35. The PDU 35 has, in addition to a payload 39, a heading made up of three fields as follows:

a header field 36 containing the receiving party's SPI for the current session, to and from addresses (in any form suitable for transport entity 14), and a message serial number c described below;

a message type field 37 indicating one of the following four message types:

HANDSHAKE

APPLICATION (payload to be passed to application)

TUNNEL (messages for nested sessions)

ALERT (error messages)

an encoding type field 38 indicates the security processing in force as determined by the current cipher suite (see below), namely, clear text, a message protected by a MAC or an encrypted message (also with a MAC).

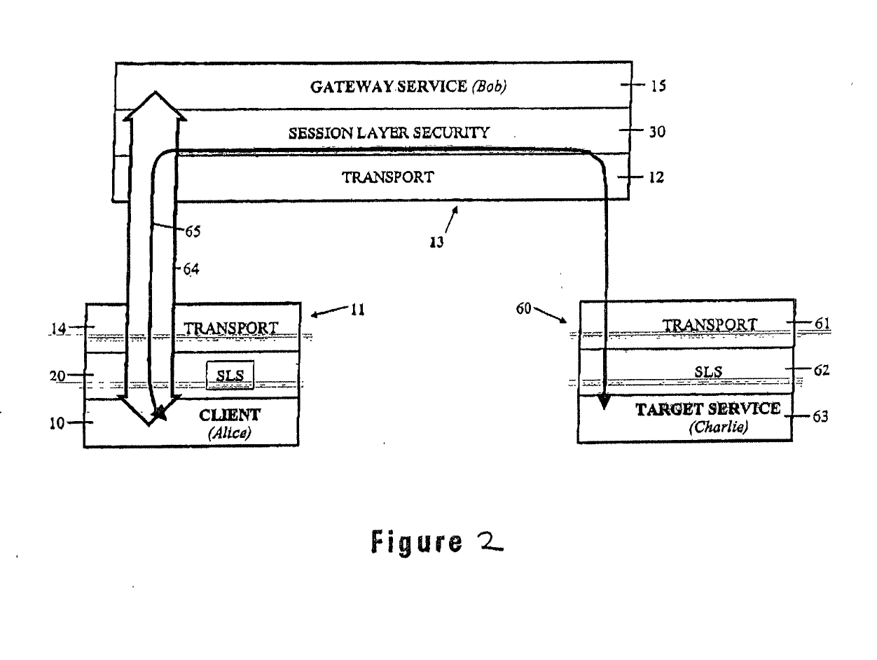

This protocol supports tunnelling, that is, the passing of PDUs through an access-controlling intermediate system to a final destination, for example, a gateway. PDUs that are to be tunnelled are encapsulated in SLS PDUs which have their message type (field 37) set to TUNNEL. Tunnelling requires the consent of the intermediate system concerned as will now be explained below with reference to FIG. 2.

As before, suppose the parties to the SLS handshake are Alice and Bob, with Alice initiating as client. When Alice sends a handshakeStart message to Bob she is expecting a handshakeReply from Bob that includes Bob's proof of the attributes Alice required of him. However, sometimes Bob is not in a position to supply the proof—for example, consider the case where Alice has the address of a service that appears to reside at Bob, but Bob is in fact a mediator (gateway application) for the service and forwards the request to another party, Charlie, who implements the service. Charlie is shown in FIG. 2 as a system 60 composed of a transport entity 61, an SLS entity 62 and a service 63. If Bob has no security restrictions of his own he can simply forward messages unchanged in both directions, and Alice and Charlie can set up an SLS session. If necessary, Bob can rewrite the to and from addresses of the messages to get them delivered to the right place. This is because the ‘to’ and ‘from’ addresses are not protected by the handshake signatures or MACs (they are in the header field 36). Everything else is protected

Assume now that Charlie has allowed Bob to broker the service provided by Charlie and also to impose his own access restrictions. This means that Bob wants to check Alice's attributes Bob has to set up an SLS session with her. But since Bob is not the real service he may well be unable to prove to Alice the properties she requires of the service. This possibility is provided for in the SLS protocol by including a ‘relay’ flag in the handshakeReply message hsR sent by Bob to Alice.

When the relay flag is true, Bob is telling Alice that he is a mediator, and so may not be able to prove all Alice's required attributes. It is up to Alice whether this is acceptable. If it is, she can complete the handshake and set up a session with Bob (the Alice-Bob session 64). Alice now needs to set up a session with the entity Bob is relaying to Charlie in this case (the Alice-Charlie session 65). Alice does this using Alice-Bob session PDUs of message type TUNNEL. These PDUs carry, as payload, PDUs for the Alice-Charlie session 65 (effectively a nested session within the Alice-Bob session). The PDUs for the Alice-Charlie session contain the messages (initially, handshake messages but subsequently encrypted message data), and the unencrypted PDU fields 36-38—since this information will be visible as such on the Bob-Charlie connection, there is no great benefit in Alice encrypting the payload of the Alice-Bob session PDUs and this step can therefore be omitted to reduce processing overhead though forming a MAC for this payload should still be done. When Bob receives an Alice-Bob session PDU with its message type set to TUNNEL, he forwards its payload as a PDU to the mediated entity (Charlie). Bob performs the security processing negotiated for his session with Alice in the usual way. If Bob receives a PDU from Alice with message type set to APPLICATION rather than TUNNEL, Bob assumes the message is for him and attempts to decrypt the payload of the PDU in the usual way.

Alice now sets up the Alice-Charlie session 65 with Charlie. Notice that once a secure channel has been set up between Alice and Charlie, then assuming Alice encrypts the payload of the Alice-Charlie session PDUs, Bob will not be able to read the payload being passed to Charlie. All he will be able to see is the header fields 36-38.

In controlling tunnelling, the control block 26 of the protocol engine 23 of Alice's system (the sending system) needs to keep a track of the session nesting. This can be done by including in the data store for each session the SPI of any immediately-nested session. Thus for the FIG. 2 example, the session data for the Alice-Bob session 64 (which would generally be the session data initially retrieved by control block 26 when Alice indicates she wants to send a message to Charlie) would show that the session was with Bob, not Charlie, and that there was a nested session with states SPI (being the SPI of the Alice-Charlie session 5). This tells the control block 26 that when sending data to Charlie the Alice-Bob session 64 is simply acting as a channel for a nested session with the consequence that the PDUs of session 64 should be set to type TUNNEL (the question of whether or not the payload of these PDUs is to be encrypted can be set by policy, by choice of cipher suite, or by an explicit flag set in the session data). The control block 26 next looks at the data for the session corresponding to the SPI in the Alice-Bob session data, namely the Alice-Charlie session data; this indicates that the receiver is Charlie (the required recipient) so that the PDUs for this session will have a message type APPLICATION and the payload will be encrypted.

If Alice wants to send a message Bob, then when the control block looks up the session data for session 64, it can see that the recipient is Bob and so PDUs can be set directly to APPLICATION and there is no need to use any nested sessions; in other words, the control block does not need to concern itself with the fact that session 64 carries a nested session as indicated by the session 65 SPI in the session 64 data. As already indicated, handling of tunnelling by the recipient (Bob) of a PDU of the message type TUNNEL is very simple and does not require any tracking mechanism—the recipient simply takes the payload of the received PDU, carries out any MAC based checking need (as indicated by the encoding type field 38) and forwards the payload (minus MAC, if present) to the entity (Charlie) indicated in the “to” address included in the header field 36 that forms part of the payload of the received PDU. Of course, the address of this entity is probably not known to Alice and Bob must supply this address, inserting it in the “to” address of the PDU to be forwarded. The address of Charlie is conveniently held by Bob in his session data for the Alice-Bob session ready for use when a TUNNEL PDU is received from alice. Bob will generally also set the “from” address to show that the message is from him.

An intended application of the above-described SLS protocol is in providing security to Hewlett-Packard's “E-speak” technology. It is useful in understanding the capabilities of the SLS protocol to consider examples of how the protocol can be deployed with such technology. A brief overview of the E-speak technology is given below to aid an understanding of the SLS deployment, a more detailed exposition of the technology can be found in [“E-speak Architecture Specification”, Hewlett-Packard Company, September 1999 available at http://www.e-speak.hp.com/].

E-speak deals in terms of “resources” described by metadata. The metadata defines resource type, attributes and security properties. Resource metadata is registered with repository in an E-speak daemon known as a “core”; this metadata can be exported from core to core. An active service registers itself as the handler for a resource with a core which then forwards messages for the resource to the handler. For present purposes, the handler and resource will be treated as equivalent to a “service” application such as the service 15 of FIG. 1; also, for simplicity, the resource and handler will not be distinguished and are jointly referred to below as a “resource”.

A client typically connects to a core, does an attribute-based look-up to find a resource and then is able to invoke the resource. The core passes messages from the client to the resource. All resources are referred to by name.

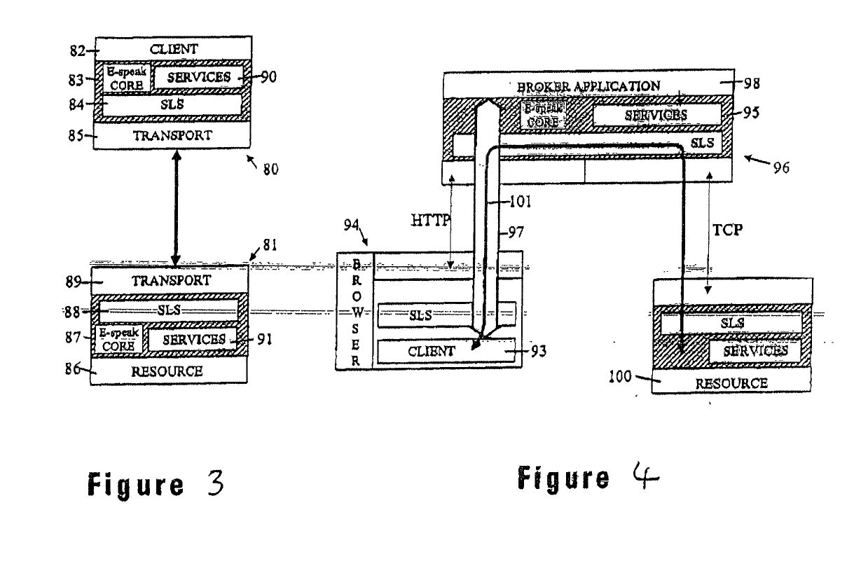

The SLS layer is intended to form a part of an E-speak core to provide security (access control and confidentiality) for communication between a client and a resource. FIG. 3 depicts this situation where a client end system 80 communicates with a resource system 81. The client end system comprises the client application 82. Similarly, the resource system comprises a resource 86, an E-speak core 87 with SLS layer 88, and a transport entity 89. The E-speak cores are shown hatched for clarity. The functionality provided by the e-speak cores 83, 87 in addition to that provided by the SLS layer, is represented by respective services blocks, 90 and 91; this additional functionality includes resource registration, metadata export, and resource discovery. Once the client 82 has determined by reference to core services 90 that resource 86 can provide a desired service and is likely to allow the client access, the client can seek to establish a secure session with resource 86 using the services of the SLS layers 83 and 88 in the manner previously described.

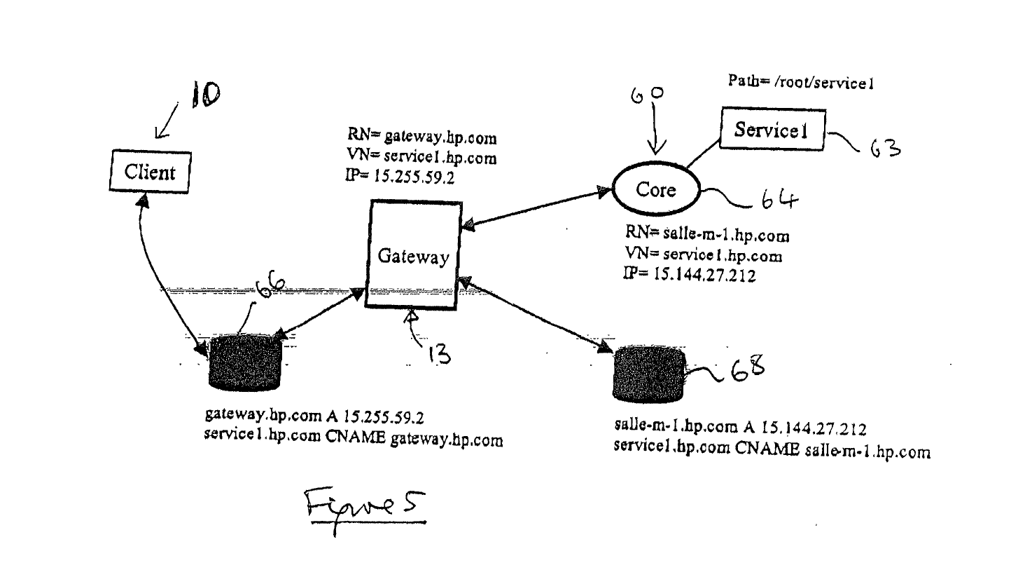

The client and E-speak core may not, however, always reside on the same end system. For example, a client may simply be a small application 93 running in a web browser 94 (see FIG. 4) with the most convenient E-speak core 95 being one hosted by a broker system 96 connected to the web. By providing browser 94 with an SLS XML plug-in, client 93 can establish a secure session 97 over an HTTP connection with broker application 98 running on system 96 and make use of core 95 to locate a target resource 100. The client can then establish a nested session 101 with the resource 100, tunnelling through the broker system; the connection between the broker system and the system running resource 100 is, for example a TCP connection. Of course, setting up the sessions 97 and 101 requires the participating parties to prove required attributes to each other in the manner already explained when describing the SLS protocol.

The above is but one approach to providing a communications channel between a client and a service provider and one to which the present invention, which will now be described in detail, is particularly applicable. However, it will be appreciated the method of the present invention is not limited to use with such an approach just described.

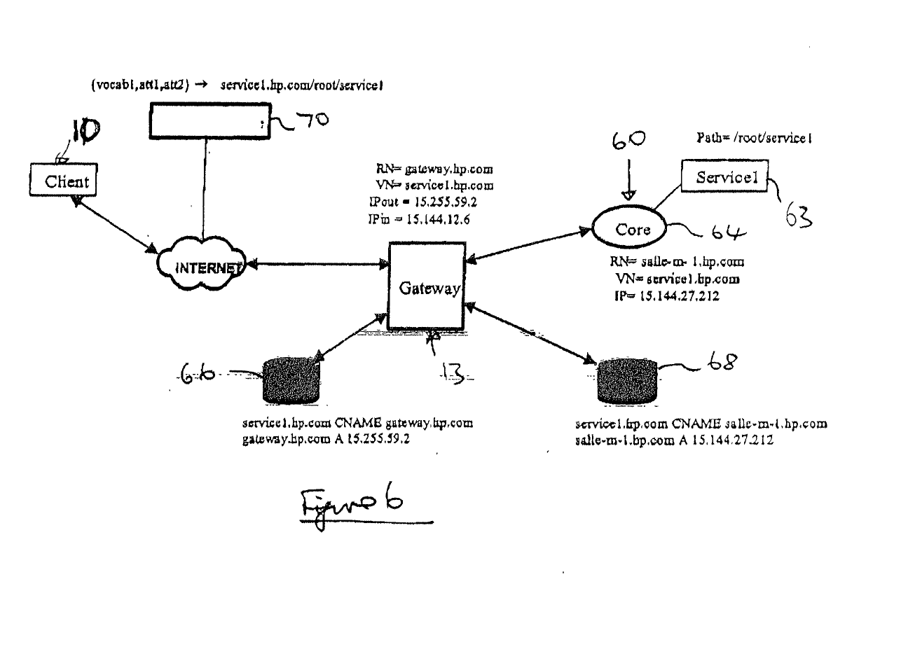

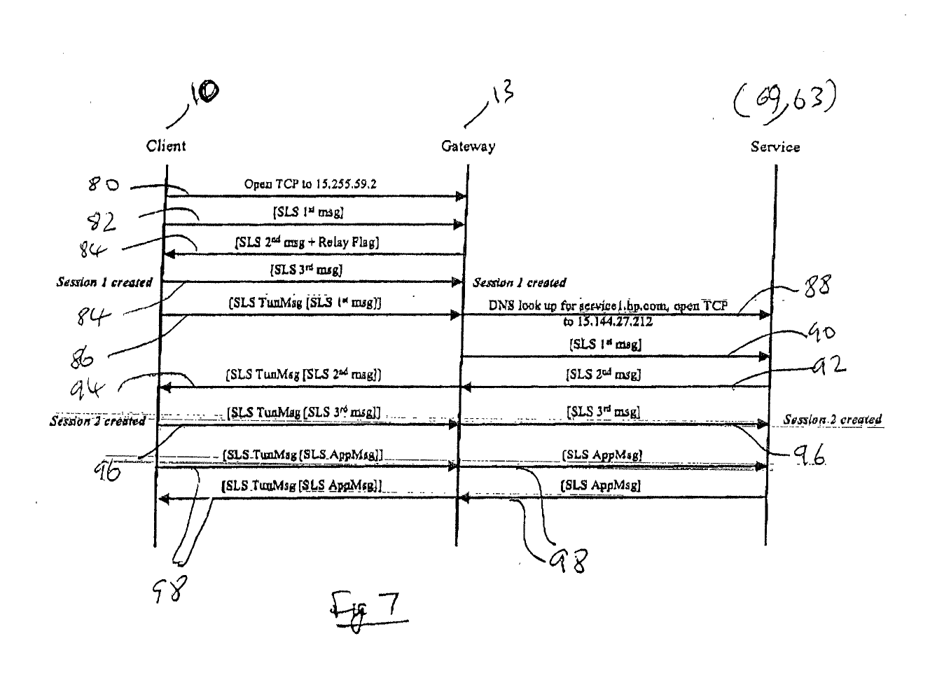

Referring now to FIG. 5, a service provider 60 wishes to expose a service, Service1 run on core machine 64 having real name salle-m-l.hp.com bound to IP address 15.144.27.212. In accordance with the present invention the path of Service1 is made known to external clients as service1.hp.com/root/service1 by allocating a virtual name service1.hp.com as the service provider and advertising it on the external network as the only reference to Service1 by any suitable means. In this particular example, the external network is assumed to be the internet and the virtual name service1.hp.com is advertised on the external DNS 66 and bound to the real name of gateway 13, in this case gateway.hp.com in turn bound to IP address 15.255.59.2. The same virtual name, service1.hp.com, is also advertised on an internal DNS 68 but is bound to the real name of the core 64 namely salle-m-1.hp.com. That is, Sevice1's virtual name service1.hp.com appears as a CNAME on the outside and inside DNSs 66,68 to gateway.hp.com and salle-m-1.hp.com, respectively. An exemplary access to tbis service, Service1 (63), by the client 10 will now be described with reference to FIG. 6.

The client 10 in this example first searches for a relevant service to meet their requirements by querying a public search service 70 with query {vocab 1, att 1, att 2} via the internet, The advertised virtual name URL <scheme>://service1.hp.com/root/service1 is returned to the client 10. The client 10 then opens a TCP connection to <scheme>://service1.hp.com/root/service1 which implies a look-up of its IP on the external DNS 66 which provides IP address 15.255.59.2, the IP address of the gateway 13.

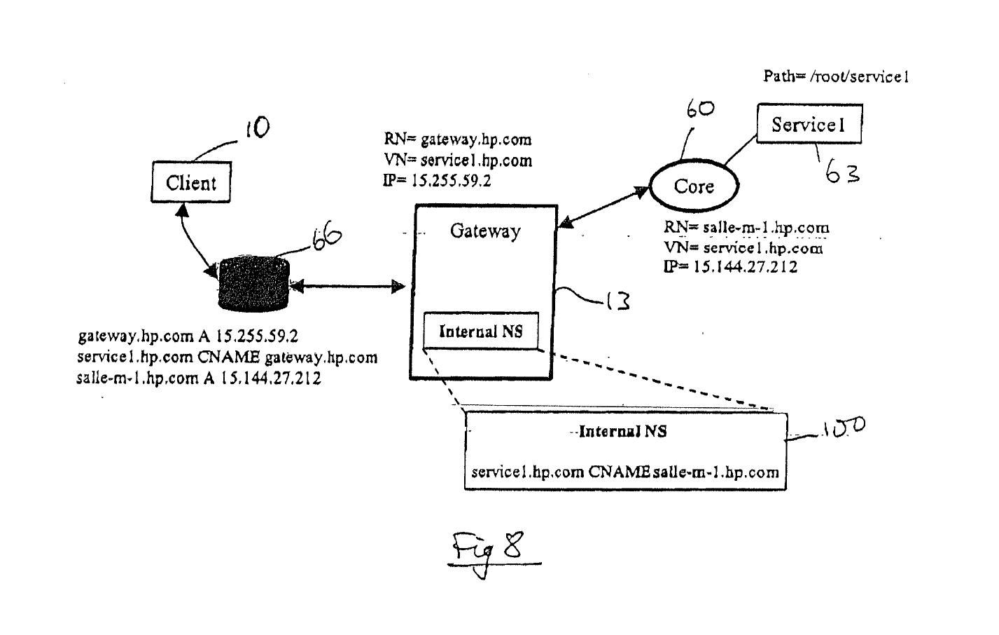

With reference now to FIG. 7, also, the client 10 then opens a TCP connection to 15.255.59.2, step 80, and sends its first SLS message. The gateway 13 sends back to the client 10 the second SLS message 84 which includes a set “relay” flag meaning that the current end point is not the one expected by the client 10 but the gateway 13. A list of tags that the client has to prove is also included in the second message. The client 10 then sends a third message 84 and at this point the first SLS session is established.

The client 10 then sends the first message 86 of a second session tunnelled in session 1, which the gateway 13 knows is addressed to service1.hp.com, as it can read the header fields of the message 86 (the client having addressed the message to service1). The gateway now looks up service1.hp.com on the internal DNS 68 at step 88 and by virtue of it being CNAME for salle-m-1.hp.com is provided with the IP address for the core 64 of 15.144.27.212. The gateway modifies the “from” field of the message and relays it to service1 (salle-m-1.hp.com/root/service1) step 90.

Service1 63 sends a second session 2 message 92 to the gateway 13 which forwards it to the client 10 step 96 who then sends a third SLS message back to service1 at step 98 via the gateway 13 to establish session 2. The session between the client 10 and service1 63 is then established and there now follows application messages 98 between them. The client 10 can now exchange end-to-end secure messages with the service provider of Service1.

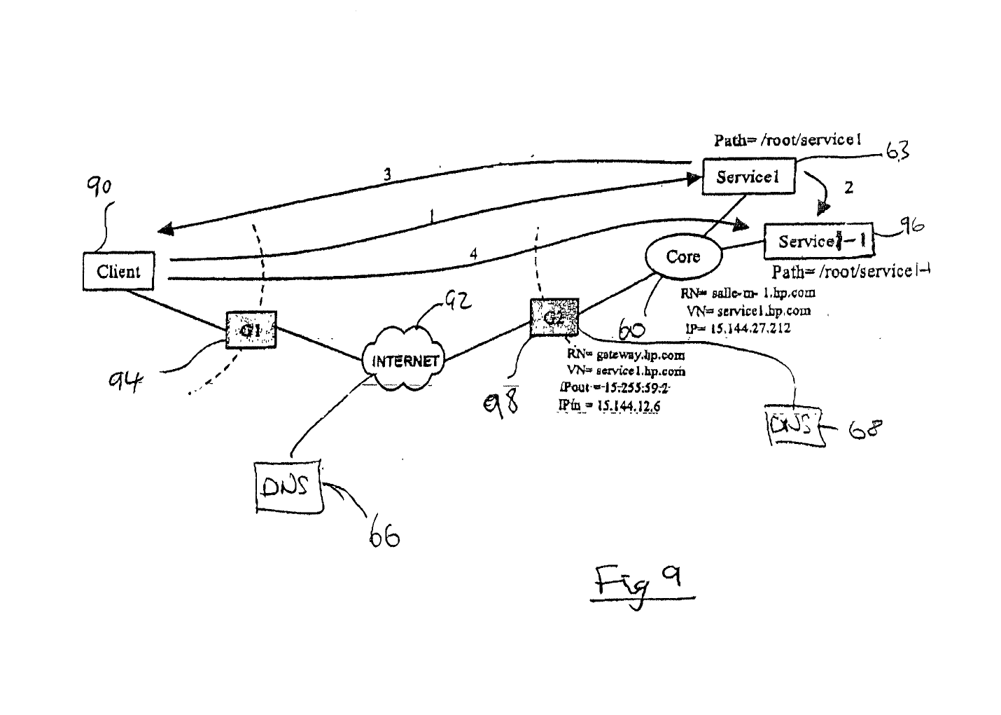

FIG. 8 illustrates how the gateway 13 may be configured when only one exposed DNS 66 is used. When the client sends a message to Service1 63, he looks up the URL for service1.hp.com in the outside DNS 66 and finds a CNAME, gateway.hp.com, and is then provided with the IP address of the gateway, 15.255.59.2. The client's message is routed to 15.255.59.2. On receipt of this message, the gateway 13 looks up service1.hp.com in its internal naming service 100 and finds salle-m-1.hp.com. The gateway 13 then looks up the IP address of salle-m-1.hp.com in the external DNS 66 and finds 15.144.27.212 and then opens a connection to 15.144.27.212.

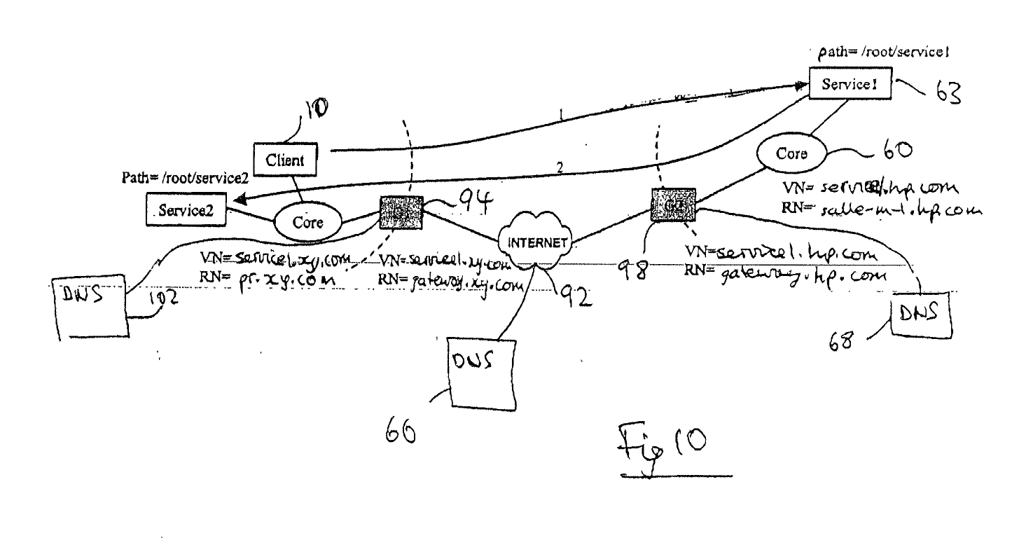

FIG. 9 illustrates an embodiment in which a further service reference is passed from the service provider to the client 10. First the client 10 accesses service1 through the gateway using its VN (<scheme>://service1.hp.com/root/service1), and invokes the Service1 as described with reference to FIG. 6. As a result of this invocation, Service1 instantiates a new service and registers it as Service1-1 with /root/service1-1 as the path on both the internal and external DNSs. Service1 then returns the complete Service1-1 URL, that is to say <scheme>://service1.hp.com/root/service1-1, to the client 10. Finally, the client accesses Service1-1 through the gateway 13. In this embodiment, client 10 is behind its own gateway 102 bridging the clients private network to the internet.

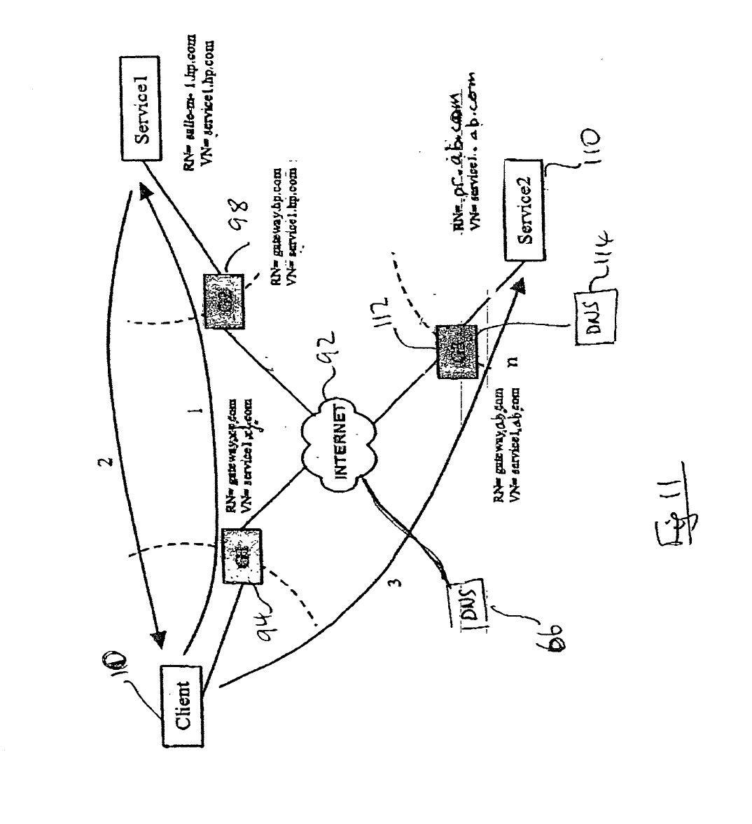

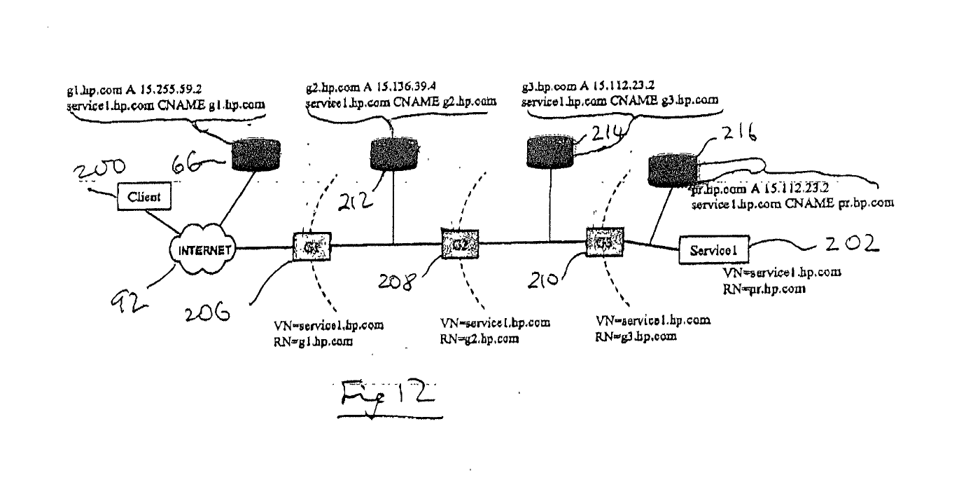

Turning now to FIG. 10, there is illustrated how client-side call-backs can be handled according to the present invention. The network arrangement is as in FIG. 11 and in which the client 10 is on a private network having a server provider core with real name pr.xy.com providing a service, Service2 100 having path/root/service. The internal network of client 10 is bridged to the internet by the gateway 94.

Client 10 accesses Service1 in the manner described with reference to FIG. 9 In this case, the client 10 passes to Service1 a virtual name reference Service2 running on the client's 10 domain, namely <scheme>://service1.xy.com/root/service2. Access to Service2 by Service1 is also according to the present invention, in that the virtual name service1.xy.com is bound on the external network to gateway.xy.com, the real name of the gateway 94, and is bound to pr.xy.com on the internal network of client 10, the virtual names being advertised on the external DNS 66 and an internal DNS 102, respectively.

FIG. 11 illustrates a variation of the interactions, illustrated in FIG. 10 in which a second service, Service2 110 is provided by a service provider not on the internal network of client 10 but on a further internal network behind gateway 112 bridging that internal network to the internet 92.

First client 10 access Service1 using its virtual name service1.hp.com the access being relayed by gateway 98 according to the present invention and as described with relation to FIGS. 5 to 9. In this case it will be assumed Service1 is a search engine and that it returns the URL of a matching service, Service2, 110 available from a server with real name pr.ab.com behind a gateway 112 with real name gateway.ab.com. The URL advertised by the service provider 110 is the virtual name service1.ab.com/root/service2, with service1.ab.com being bound to real name gateway.ab.com on the external DNS 66 and to pr.ab.com on a DNS 114 internal to the service provider 110, in accordance with the present invention. The client 10 can then connect to Service2 behind gateway 112 analogously to the method of connecting to Service1.

Turning now to FIG. 12, there is shown a network arrangement in which a client 200 can connect via the internet 92 again, in this example, to a service, Service1 202 across multiple enclaves demarcated by a series of three gateways 206,208,210 with respective real names g1.hp.com, g2.hp.com and g3.hp.com and respective IP addresses of 15.255.59.2, 15.136.39.4 and 15.112.23.2. The external network 92 and the network behind each gateway 206,208,210 has associated with it a respective DNS 66, 212,214,216. The service provider of Service1, in accordance with the present invention, advertises the same virtual name the service provider has allocated to Service1 (service1.hp.com) on each internal DNS 212,214,216 and external DNS 66. In each case it is set as an alias (CNAME) for the respective gateway real name on the DNS of the network immediately external to the respective gateway.

The virtual name service1.hp.com therefore provides a global address which can be used, unchanged, to define a routing path from the client 200 to the required Service1 at real name pr.hp.com on the internal network behind the gateway 210.

1. A method for a service provider on a private network to provide a service for an external client on an external network via a gateway bridging the private and external networks, including the service provider carrying out the steps of:
allocating a virtual name to the service provider;
making the virtual name available to a client on the external network;
binding the virtual name to the routing address of the gateway on the external network; and
binding the virtual name to the routing address of the service provider on the private network.

2. A method as claimed in claim 1 in which virtual name is bound to the routing address of the gateway and the routing address of the service provider by way of an external domain name server and private domain name server, respectively.

3. A method as claimed in claim 1 in which the virtual name is bound to the routing address of the service provider on a internal naming service.

4. A method as claimed in any preceding claim in which the external network includes the internet.

5. A method as claimed in any preceding claim in which the client and the service provider communicate by way of tunnelled session via the gateway.

6. A method as claimed in claim 5 in which messages communicated between the client and service provider are encrypted.

7. A method as claimed in claim 1 in which the client is on a second internal network distinct from the internal network of the service provider and a second gateway bridges the second internal network and external network, the method including the steps of:
allocating a second virtual name to the client;
making the second virtual name available to the service provider;
binding the second virtual name to the routing address of the second gateway on the external network; and
binding the second virtual name to the routing address of the client on the second internal network.

8. A method as claimed in claim 1 in which there is a second service provider on a second private network able to communicate with an external network via a second gateway bridging the second private and external network, including the steps of:
allocating a second virtual name to the second service provider;
making the second virtual name available to a client;
binding the second virtual name to the routing address of the second gateway on the external network; and
binding the second virtual name to the routing address of the second service provider on the second private network.

9. A method as claimed in claim 1, in which the external network includes a further private network containing the private network of the service provider and there is further gateway bridging the further private network to the portion of the external network which is external to the further private network, the method including the additional steps of:
binding the virtual name to routing address of the further gateway on the portion of the external network which is external to the further private network.

10. A method of providing access to a server on a private network from an external client on an external network via a gateway bridging the private and external networks, the gateway supporting tunnelling of second messages to said server by encapsulating them in first messages routed to the gateway, the method involving:
(a) allocating a virtual name to the server and mapping it by a first mapping to the routing address of the gateway on the external network and by a second mapping to the routing address of the server on the private network;
(b) at said external client, using the virtual name to address a said first message and a said second message, the former encapsulating the latter;
(c) using the first mapping to route the first message, with its encapsulated second message, to the gateway; and
(d) using the second mapping to route the second message extracted at the gateway from the first message, to the server.

11. A method as claimed in claim 10 in which said first messages are encrypted.
